(19) United States
(12) Patent Application Publication
(10) Pub. No.: US 2008/0250211 A1
(43) Pub. Date: Oct. 9, 2008

(54) Cache control method, cache device, and microcomputer

(75) Inventor: Junichi Imamizu, Kanagawa (JP)

Correspondence Address: FOLEY AND LARDNER LLP;SUITE 500, 3000 K STREET NW, WASHINGTON, DC, 20007, US

(73) Assignee: c/o NEC ELECTRONICS CORPORATION

(21) Appl. No.: 12/076,784

(22) Filed: Mar. 24, 2008

(30) Foreign Application Priority Data
Apr. 5, 2007 (JP) 2007-099353

(51) Int. Cl. G06F 12/00

(52) U.S. Cl. 711/154; 711/E12.001

(57) ABSTRACT

when a non-subsequent read occurs which is a read from a non-subsequent address not consecutive to the previous read address, a first cache memory sequentially caches respective data of the non-subsequent address and n addresses following the non-subsequent address, where n is an integer of one or greater, while the cached data of the n addresses are stored into a second cache memory, and subsequently, until the next non-subsequent read is performed, data of addresses following the last one of the n addresses are sequentially read from a memory, not via the first cache memory and stored into the second cache memory. In response to subsequent reads following the non-subsequent read, the second cache memory outputs the data of read addresses specified by the subsequent reads.

### BACKGROUND OF THE INVENTION

1. Field of the Invention

The present invention relates to a technique of caching data stored in memory.

2. Description of Related Art

In microcomputer systems, executable programs, data, and the like are stored in a main memory (hereinafter simply called a memory), and a CPU (Central Processing Unit) reads the executable programs and data from the memory and executes the executable programs. The processing speed of the system depends on the speeds at which the CPU reads the executable program and data.

In order to make read speed faster, a technique is used which provides a cache memory, which is faster in operating speed than the memory, in between the CPU and the memory. This technique utilizes locality of reference (LOF) in reading by the CPU. The LOF includes temporal locality and spatial locality, and the temporal locality means that the probability of referencing again in the near future an address on memory that has been just referenced is greater, and the spatial locality means that when an address on memory has been recently referenced, the probability of referencing an address near it is greater.

In a system provided with a cache memory, according to the LOF, parts of an executable program and data whose probability of being referenced is greater are read from the memory and stored in the cache memory in advance, and if a part of the executable program or data that the CPU is about to read is in the cache memory, the cache memory outputs it to the CPU. By this means, the number of cycles required for the CPU to read the executable program or data can be reduced, and also the number of program execution cycles can be reduced.

Various techniques for reducing the requisite capacity of cache memory have been proposed to reduce chip area and cost. Here the technique described in Japanese Patent Application Laid-Open Publication No. S62-151936 (Reference 1) will be described using FIG. 6.

FIG. 6 shows a cache device of FIG. 1 of Reference 1 with each functional block being labeled with its function name for easiness to understand. The cache device comprises a prefetch address register 1, comparator/registers 2, 3, 4, cache memories 5, 6, 7, instruction queues 8, 9, 10, and an instruction register 11. The comparator/register functions as a register to store the address of an instruction stored in a corresponding one of the cache memories and also as a comparator to compare the content of the register and the content of the prefetch address register 1. In FIG. 6, numeral 12 indicates a jump instruction identifying signal. Since in Reference 1 queues such as the instruction queues are referred to as “kyu” in Japanese, in the Japanese version of this specification, “kyu” is used in the description of Reference 1, while “kyuu” is used in the description of the present invention.

Instructions at consecutive addresses in external memory are always prefetched in the instruction queues 8, 9, 10. Instructions in the instruction queues 8, 9, 10 are usually read into the instruction register 11 except immediately after the execution of a jump instruction (also called a branch instruction) according to the jump instruction identifying signal 12. In contrast, as to several instructions after the execution of a jump instruction, an instruction in a cache memory whose address coincides with the prefetch address input in the prefetch address register 1 is read into the instruction register 11 according to the comparison results of the comparator/registers.

A program usually includes instructions whose addresses are consecutive and an instruction of a non-consecutive address due to a jump instruction. In this technique, with cache memories and instruction queues both provided, instructions from the instruction queues are executed except immediately after the execution of a jump instruction, and as to only several instructions after the execution of a jump instruction, instructions from the cache memories are executed. That is, because instructions of consecutive addresses are stored in the instruction queues, during the execution of instructions of consecutive addresses, the addresses of instructions in the cache memories and the address stored in the prefetch address register are not compared. Further, since the cache memories need only store several instructions after the execution of a jump instruction, the requisite capacity of cache memory can be reduced.

In the technique described in Reference 1, a CPU reads instructions of consecutive addresses via the instruction queues. In the past when the difference in operation speed between CPUs and memory was small, reading via the instruction queue did not much reduce CPU performance. In these years, however, CPUs and memory often differ in operation speed by a factor of several or greater, and thus it takes time until data is stored into the instruction queue. Hence, there is the problem that if the CPU reads instructions of consecutive addresses via the instruction queue, CPU performance is greatly reduced.

### SUMMARY

According to an aspect of the present invention, there is provided a cache control method. In this method, when a non-subsequent read occurs which is a read from a non-subsequent address not consecutive to the previous read address, a first cache memory sequentially caches respective data of the non-subsequent address and n addresses following the non-subsequent address, where n is an integer of one or greater, while the cached data of the n addresses are stored into a second cache memory, and subsequently, until the next non-subsequent read is performed, data of addresses following the last one of the n addresses are sequentially read from a memory, not via the first cache memory and stored into the second cache memory. In response to subsequent reads following the non-subsequent read, the second cache memory outputs the data of read addresses specified by the subsequent reads.

According to other aspects of the present invention, there are provided a device or system for implementing the method according to the above aspect and a microcomputer comprising the device.

According to the technique of the present invention, the requisite capacity of the cache memory can be reduced with preventing reduction in CPU performance.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows a microcomputer according to an embodiment of the present invention;

FIG. 2 shows the structure of an entry of cache memories in the microcomputer of FIG. 1;

FIG. 3 is an operation timing chart of a memory in the microcomputer of FIG. 1;

FIG. 4 is a read timing chart (part 1) of a CPU in the microcomputer of FIG. 1;

FIG. 5 is a read timing chart (part 2) of the CPU in the microcomputer of FIG. 1; and

FIG. 6 illustrates a prior art technique.

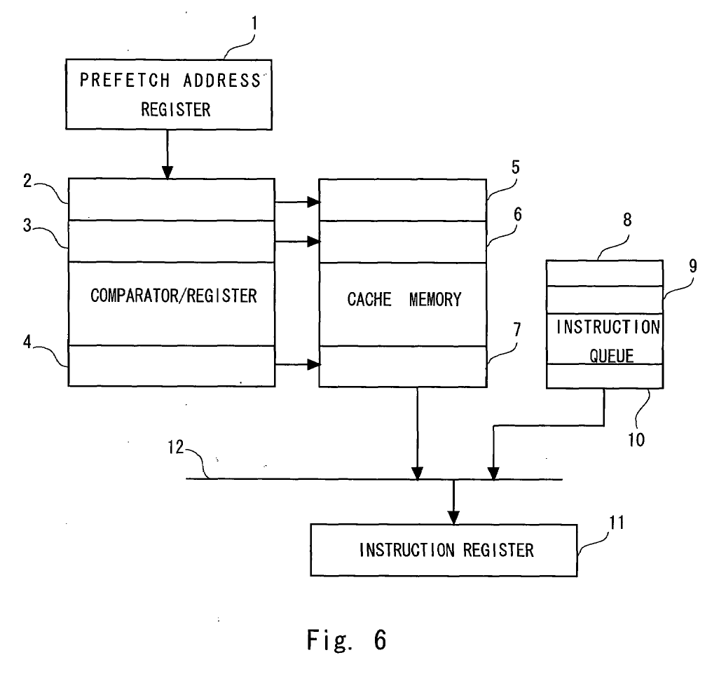

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

An embodiment of the present invention will be described below with reference to the drawings.

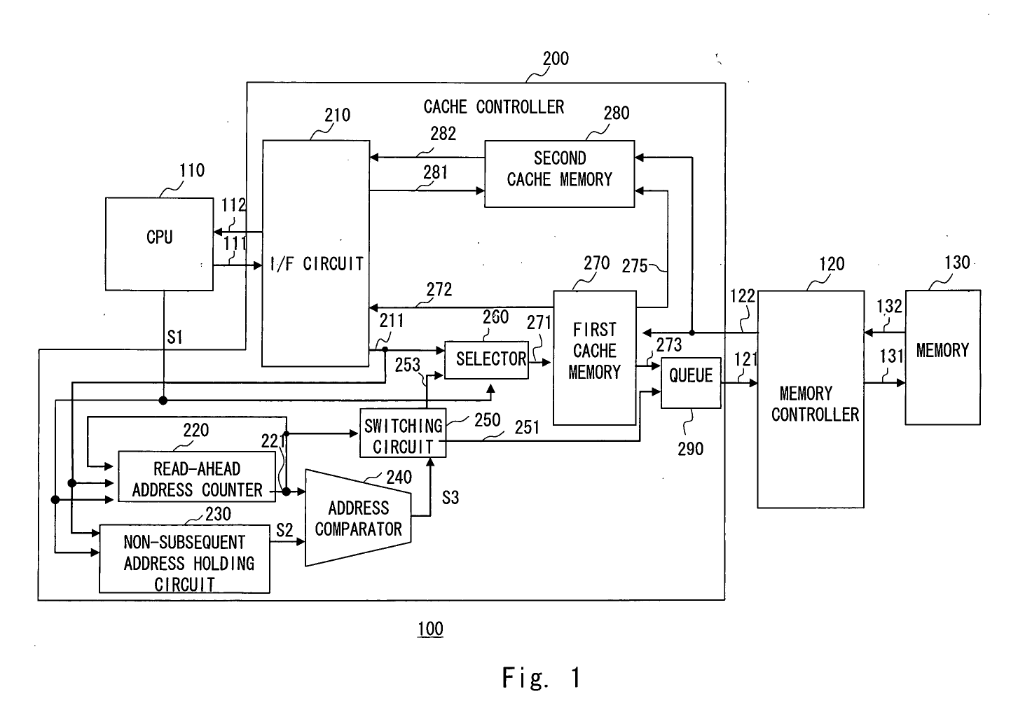

FIG. 1 shows a microcomputer 100 according to an embodiment of the present invention. The microcomputer 100 comprises a CPU 110, a cache controller 200, a memory controller 120, and a main memory (hereinafter simply called a memory) 130. For easiness to understand the subject matter of the present invention, only parts related to the present invention are shown, with an illustration and description of the other parts common to most microcomputers being omitted.

The cache controller 200 as a cache device is connected between the CPU 110 and the memory controller 120. As shown in FIG. 1, the cache controller 200 comprises an interface circuit (hereinafter called an I/F circuit) 210 connecting to the CPU 110, a read-ahead address counter 220, a non-subsequent address holding circuit 230, an address comparator 240, a switching circuit 250, a selector 260, a first cache memory 270, a second cache memory 280, and a queue 290.

There are two types of data that the CPU 110 reads. One type is instruction data to be executed and the other is data other than instructions. The CPU outputs the address (fetch address) of the instruction data when reading instruction data, and outputs the address of the data when reading data other than instructions. Hereinafter, data that the CPU 110 reads is simply called “data” regardless of the type of data, and the address that the CPU 110 outputs to read data is called a “read address”.

When reading data, the CPU 110 outputs the address of the data as a read address. Also, the CPU 110 outputs a signal S1 indicating whether the current read address is a subsequent address to the address of the previous read data together with the read address.

The subsequent address means the address consecutive to the previous read address. A not subsequent address means an address not consecutive to the previous read address and is called a non-subsequent address hereinafter. Further, read from a subsequent address is called “subsequent read” and read from a non-subsequent address is called “non-subsequent read”.

In the microcomputer 100 of the present invention, the signal S1 indicating whether the current read address is a subsequent address or a non-subsequent address indicates being a non-subsequent address when high and being a subsequent address when low. This signal is called a non-subsequent signal hereinafter. The CPU 110 outputs the non-subsequent signal S low when outputting a subsequent address and high when outputting a non-subsequent address.

The read address and the non-subsequent signal S5 output by the CPU 110 are input to the cache controller 200. To be Specific, the read address is input to the interface circuit 210 via an address bus 111, and the non-subsequent signal S is input to the read-ahead address counter 220, non-subsequent address holding circuit 230, and selector 260.

The interface circuit 210 outputs the read address from the CPU 110, to the second cache memory 280 via a second cache address input bus 281 and to the read-ahead address counter 220, non-subsequent address holding circuit 230, and selector 260 via a read address bus 211.

Moreover, when data is output on a second cache data output bus 282 or a first cache data output bus 272, the interface circuit 210 outputs this data to the CPU 110 via a data bus 112. It is data from the second cache memory 280 that is output on the second cache data output bus 282, and it is data from the first cache memory 270 that is output on the first cache data output bus 272. These two cache memories will be described later.

The read-ahead address counter 220, non-subsequent address holding circuit 230, address comparator 240, switching circuit 250, selector 260, and queue 290 function together as a read-ahead processing unit that performs a read-ahead process when a non-subsequent read occurs.

The read-ahead address counter 220 receives the read address and the non-subsequent signal S1 from the interface circuit 210 and the CPU 110 and generates read-ahead addresses in response to the non-subsequent signal S1.

To be specific, when the read address is a non-subsequent address, that is, when the non-subsequent signal S1 is high, the read-ahead address counter 220 adds 1 to the read address, thereby generating a read-ahead address that is the read address+1 and holds it with outputting to the address comparator 240 and the switching circuit 250 via a read-ahead address bus 221.

In contrast, when the read address is a subsequent address, that is, when the non-subsequent signal S1 is low, the read-ahead address counter 220 adds 1 to the address held by itself (hereinafter called a held address), thereby generating a read-ahead address that is the held address+1 and holds it with outputting to the address comparator 240 and the switching circuit 250 via a read-ahead address bus 221.

The non-subsequent address holding circuit 230 receives the read address and the non-subsequent signal S1 from the interface circuit 210 and the CPU 110 and, when the non-subsequent signal S1 is high, i.e., when the read address is a non-subsequent address, holds this address with outputting this address as a non-subsequent address signal S2 to the address comparator 240 and, when the non-subsequent signal S1 is low, outputs the held non-subsequent address to the address comparator 240.

That is, when the read address is a subsequent address, the read-ahead address (the held address+1) from the read-ahead address counter 220 and the non-subsequent address held in the non-subsequent address holding circuit 230 are input to the address comparator 240. In contrast, when the read address is a non-subsequent address, the read-ahead address (the read address+1) generated in the read-ahead address counter 220 and that read address from the non-subsequent address holding circuit 230 are input to the address comparator 240.

The address comparator 240 compares the read-ahead address and the non-subsequent address signal S2 and outputs a cache access signal S3 to control the first cache memory 270 to cache or not according to the comparison result. To be specific, for read-ahead addresses that are n number of addresses following the non-subsequent address signal S2, where n is an integer of 1 or greater, the address comparator 240 outputs the cache access signal S3 indicating cache access. In contrast, for read-ahead addresses that are (n+1)th and later addresses subsequent to the non-subsequent address signal S2, the address comparator 240 outputs the cache access signal S3 inactive indicating non-cache access.

In the present embodiment, the cache access signal S3 indicates accessing the cache when high and not accessing the cache when low. The address comparator 240 outputs the cache access signal S3 high or low according to its comparison result.

The cache access signal S3 is output to the switching circuit 250, which switches which to supply the read-ahead address from the read-ahead address counter 220 to, the selector 260 or the queue 290 according to the cache access signal S3. To be specific, the switching circuit 250 outputs the read-ahead address to the selector 260 via a cache address bus 253 when the cache access signal S3 is high indicating cache access and in contrast, to the queue 290 via a read-ahead queue set address bus 251 when the cache access signal S3 is low.

The selector 260 selects which to be output to the first cache memory 270, either the read address from the interface circuit 210 or the read-ahead address from the switching circuit 250. To be specific, the selector 260 outputs the read address from the interface circuit 210 onto a first cache address input bus 271 when the non-subsequent signal S1 is high and in contrast, the read-ahead address from the switching circuit 250 onto the first cache address input bus 271 when the non-subsequent signal S1 is low.

The address (the read address from the interface circuit 210 or the read-ahead address) output on the first cache address input bus 271 is input to the first cache memory 270. The first cache memory 270 performs a cache operation only when an address from the selector 260 is output on the first cache address input bus 271.

In the cache operation, the first cache memory 270 confirms whether the same address as the one (the read address or the read-ahead address) from the selector 260 is stored in itself.

If stored, the first cache memory 270 outputs data (cache data) corresponding to that address to the interface circuit 210 via the first cache data output bus 272 and also outputs that address and the data corresponding to that address to the second cache memory 280 via a cache read address data bus 275.

On the other hand, if not stored, the first cache memory 270 outputs the address from the selector 260 to the queue 290 via a cache address output bus 273. After outputting the address from the selector 260 to the queue 290, when data corresponding to this address is output from the memory controller 120 onto a memory read address data bus 122, the first cache memory 270 stores this data and the address of this data in itself.

When the first cache memory 270 outputs the address (the read address from the interface circuit 210 or the read-ahead address) onto the cache address output bus 273, the queue 290 stores this address in itself and outputs it to the memory controller 120 via a memory read address bus 121. Also, when the read-ahead address is output from the switching circuit 250 onto the read-ahead queue set address bus 251, the queue 290 stores this read-ahead address in itself and outputs it to the memory controller 120 via the memory read address bus 121.

The memory controller 120 is a circuit that controls the memory 130 and issues a read request with outputting the address output from the queue 290 via the memory read address bus 121, to the memory 130 via a memory address bus 131. Further, when data corresponding to that address is output from the memory 130 onto a memory data bus 132 in response to this read request, the memory controller 120 outputs this data and the address corresponding to this data onto the memory read address data bus 122.

When the read address is output from the interface circuit 210 onto the second cache address input bus 281, the second cache memory 280 confirms whether data corresponding to the read address is stored in itself and if stored, outputs that data to the interface circuit 210 via a cache data output bus 282.

When the first cache memory 270 outputs data and the address corresponding to the data onto the cache read address data bus 275, the second cache memory 280 stores this data and the address in itself. Also, when the memory controller 120 outputs data and the address corresponding to this data onto the memory read address data bus 122, the second cache memory 280 stores this data and the address in itself.

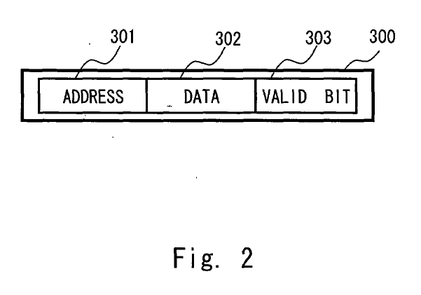

The first cache memory 270 and the second cache memory 280 comprise multiple entries as a usual cache memory. As shown in FIG. 2, each of the entries 300 comprises an address 301, data 302 corresponding to the address 301, and a valid bit 303 indicating whether the address 301 and the data 302 are valid or not.

Next, the operation of the microcomputer 100 of FIG. 1 will be described specifically using a specific example.

First, there will be described the case where, with data of addresses 0 to 3 being not stored in the first cache memory 270 and the second cache memory 280, the CPU 110 reads data from address 0 as a non-subsequent address.

The CPU 110 outputs the non-subsequent signal S1 high only while outputting address 0 onto the address bus 111 and thereafter continues to output the non-subsequent signal S1 low until it outputs the next non-subsequent address onto the address bus 111.

The CPU 110 outputs address 0 to the interface circuit 210 via the address bus 111 with outputting the non-subsequent signal S1 high.

The interface circuit 210 outputs address 0 to the second cache memory 280, the read-ahead address counter 220, the non-subsequent address holding circuit 230, and the selector 260.

The second cache memory 280 compares each of its own entries with address 0. At this point since the data of address 0 is not stored therein, a miss hit occurs.

Because the non-subsequent signal S1 is high, the read-ahead address counter 220 generates and holds a read-ahead address (i.e., address 0+1=address 1) while outputting the read-ahead address, i.e., address 1 to the address comparator 240 and the switching circuit 250.

Further, because the non-subsequent signal S1 is high, the non-subsequent address holding circuit 230 reads and holds the non-subsequent address, i.e., address 0 while outputting address 0 as the non-subsequent address signal S2 to the address comparator 240.

The address comparator 240 compares the read-ahead address from the read-ahead address counter 220 and the non-subsequent address signal S2 from the non-subsequent address holding circuit 230 and according to the comparison result, outputs the cache access signal S3 high or low.

In this specific example, with using three for the n, the address comparator 240 outputs the cache access signal S3 high for read-ahead addresses that are three addresses following the non-subsequent address signal S2 and in contrast, for read-ahead addresses that are fourth and later addresses subsequent to the non-subsequent address signal S2, outputs the cache access signal S3 low.

At this point, because the read-ahead address (address 1) is the first address following the non-subsequent address signal S2 (address 0), the address comparator 240 outputs the cache access signal S3 high.

Since the cache access signal S3 is high, the switching circuit 250 outputs the read-ahead address (address 1) from the read-ahead address counter 220 to the selector 260.

Since the non-subsequent signal S1 is high, the selector 260 selects address 0 from the two of address 0 from the interface circuit 210 and address 1 from the switching circuit 250 and outputs to the first cache memory 270.

The first cache memory 270 compares each of its own entries with address 0. At this point since the data of address 0 is not stored therein, a miss hit occurs. The first cache memory 270 outputs address 0 to the queue 290.

The queue 290 stores address 0 in itself and outputs address 0 to the memory controller 120. Accordingly, the memory controller 120 reads out data corresponding to address 0 from the memory 130. This data together with address 0 is output onto the memory read address data bus 122.

The first cache memory 270 stores the data output on the memory read address data bus 122 together with address 0 in itself and outputs the data to the interface circuit 210 via the first cache data output bus 272.

The second cache memory 280 stores address 0 and the data output on the memory read address data bus 122 in itself.

The interface circuit 210 transfers the data output on the first cache data output bus 272 onto the data bus 112. The CPU 110 reads in the data of address 0 output on the data bus 112, thereby finishing the read of the data of address 0.

Note that after the CPU 110 finishes outputting address 0, the non-subsequent signal S1 is driven low.

The read-ahead address counter 220 sequentially generates consecutive read-ahead addresses, addresses 1, 2, 3, . . . , until the non-subsequent signal S1 becomes high the next time while outputting them to the switching circuit 250 and the address comparator 240. During this time, the non-subsequent signal S1 is low and the non-subsequent address signal S2 output from the non-subsequent address holding circuit 230 continues to be address 0.

While the read-ahead address counter 220 generates and outputs addresses 1, 2, 3 as read-ahead addresses, the cache access signal S3 from the address comparator 240 is high because these read-ahead addresses are three addresses following the non-subsequent address signal S2 (address 0). Hence, the switching circuit 250 outputs the read-ahead addresses to the selector 260. Moreover, because the non-subsequent signal S1 is low, the selector 260 outputs the read-ahead addresses from the switching circuit 250 to the first cache memory 270. By this means, the data of addresses 1, 2, 3 are read out from the memory 130 and stored into the first cache memory 270 and the second cache memory 280.

In contrast, when the read-ahead address counter 220 generates and outputs address 4 as a read-ahead address, the cache access signal S3 from the address comparator 240 becomes low because address 4 is the fourth address subsequent to address 0. Hence, the switching circuit 250 outputs address 4 to the queue 290. In this case, because it is not the first cache memory 270 that outputs address 4 to the queue 290, the data of address 4 read out from the memory 130 via the queue 290 and the memory controller 120, and address 4 are stored into only the second cache memory 280.

That is, once the CPU 110 reads from a non-subsequent address, the data of addresses (read-ahead addresses) following this non-subsequent address are sequentially read out from the memory 130 until the next non-subsequent read. Although the data of the read-ahead addresses that are three addresses following the non-subsequent address are stored into both the first cache memory 270 and the second cache memory 280, the data of read-ahead addresses that are the fourth and later addresses subsequent to the non-subsequent address are stored into only the second cache memory 280.

After reading from address 0, i.e., a non-subsequent address, when in order to read from subsequent addresses, i.e., address 1 and the later addresses, the CPU 110 outputs the subsequent addresses onto the address bus 111, the data of the subsequent addresses are already stored in the second cache memory 280 by reading ahead. Hence, at the beginning of each subsequent read, the second cache memory 280 is ready to output the data of the read address of the subsequent read to the CPU 110.

As such, after a non-subsequent read occurs, the data of a total of four consecutive addresses, i.e., the non-subsequent address and three addresses following it are stored into the first cache memory 270 and the second cache memory 280. The data of the fourth and later addresses subsequent to the non-subsequent address are stored into only the second cache memory 280.

Next, there will be described the case where, with the data of addresses 0 to 3 being stored in the first cache memory 270, the CPU 110 reads the data at consecutive addresses starting from a non-subsequent address 0.

In this case, because the data of address 0 is stored in the first cache memory 270, the data of address 0 is output from the first cache memory 270 to the CPU 110 via the first cache data output bus 272.

Thereafter, addresses 1, 2, 3 as read-ahead addresses generated by the read-ahead address counter 220 are output to the first cache memory 270. These addresses and corresponding data stored in the first cache memory 270 are output to the second cache memory 280 via the cache read address data bus 275 and stored into the second cache memory 280.

Read-ahead addresses starting from address 4 generated by the read-ahead address counter 220 are output to the queue 290. The data of these read-ahead addresses read out from the memory 130 via the queue 290 and the memory controller 120 are stored together with the corresponding addresses into only the second cache memory 280.

Thereafter, when the CPU 110 reads data at a subsequent address, i.e., address 1 or a later address, at the beginning of the read, the data of the read address is already stored in the second cache memory 280 by reading ahead. Hence, the data is output from the second cache memory 280 to the CPU 110.

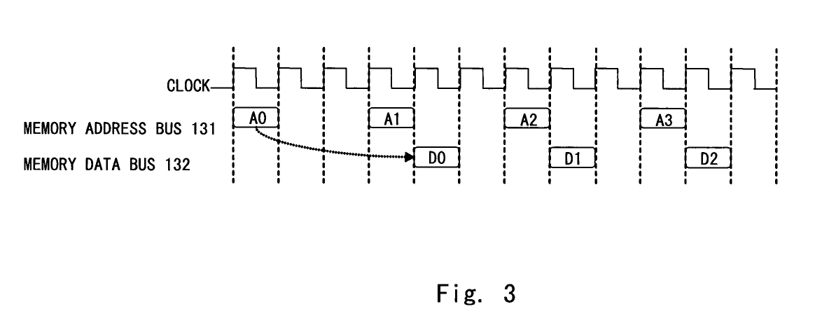

Next, the data read by the CPU 110 in the microcomputer 100 of the present embodiment will be described in detail with reference to the timing charts of FIGS. 3 to 5.

In the timing charts of FIGS. 3 to 5, A0 to A7 indicate addresses, and D0 to D7 indicate data corresponding to the respective addresses. “Hit” indicates that the data of the address output on the first cache address input bus 271 from the selector 260 is stored in the first cache memory 270, and “Miss” indicates that the data of the address output on the first cache address input bus 271 from the selector 260 is not stored in the first cache memory 270.

FIG. 3 is an operation timing chart of the memory 130 used in the previous specific example. The memory 130 is a memory of latency 4.

As shown in FIG. 3, four clock cycles after an address is output onto the memory address bus 131, data corresponding to that address is output onto the memory data bus 132. That is, the frequency of outputting addresses onto the memory address bus 131 when reading data from the memory 130 and the frequency of data being output onto the memory data bus 132 are at fastest once in each three cycles.

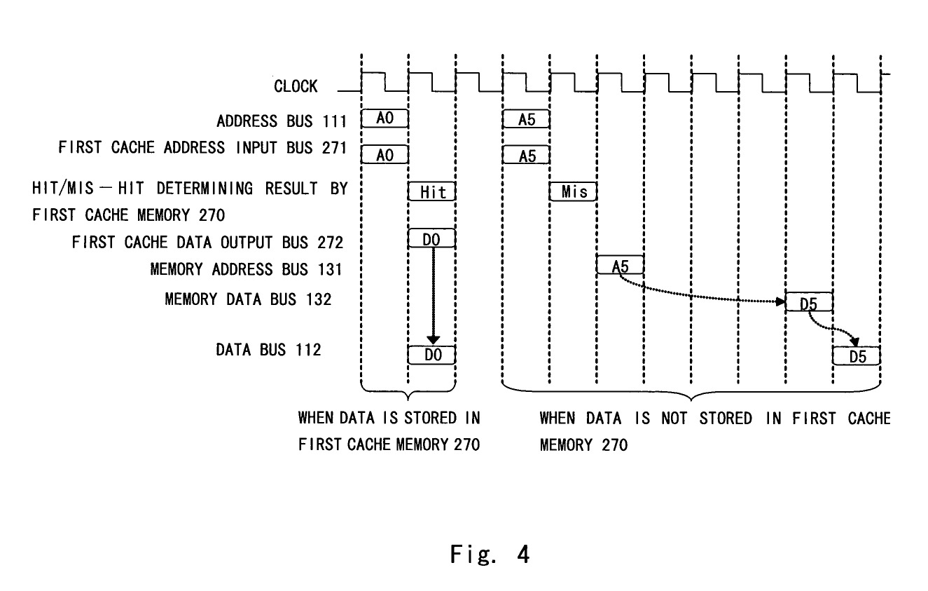

FIG. 4 is a timing chart showing a non-subsequent read for data stored in the first cache memory 270 and a non-subsequent read for data not stored therein.

As shown in FIG. 4, where data D0 of non-subsequent address A0 is stored in the first cache memory 270, in the same cycle that the CPU 110 outputs address A0 onto the address bus 111, address A0 is output onto the first cache address input bus 271. Because data D0 of address A0 is stored in the first cache memory 270, a Hit occurs and in the next cycle, data D0 is output from the first cache memory 270 to the CPU 110 via the first cache data output bus 272 and the data bus 112.

Where data D5 of non-subsequent address A5 is not stored in the first cache memory 270, when the CPU 110 outputs address A5 onto the address bus 111, it takes two cycles to determine that data D5 is not in the first cache memory 270 (Miss), and it takes four cycles to read out data D5 from the memory 130 onto the memory data bus 132, and it takes one cycle for data D5 to be output onto the data bus 112 after output onto the memory data bus 132. Hence, seven cycles after the CPU 110 outputs address A5 onto the address bus 111, data D5 is output onto the data bus 112.

Suppose the example case where the CPU 110 reads at a frequency of once in each three cycles. Further suppose that the respective data of a non-subsequent address and three addresses following it output from the CPU 110 are not stored in the first cache memory 270.

In this case, seven cycles after the CPU 110 outputs the non-subsequent address onto the address bus 111 for a non-subsequent read, the data of the non-subsequent address is output onto the data bus 112.

During this time, reading ahead is performed in the cache controller 200, and when the CPU 110 outputs a subsequent address that is the non-subsequent address+1 onto the address bus 111, the data of the non-subsequent address+1 is already stored in the second cache memory 280. Hence, in the cycle next to the cycle when the CPU 110 outputted the non-subsequent address+1, the data of the non-subsequent address+1 is output onto the data bus 112.

That is, in this example case, also for subsequent addresses of which the data are not stored in the first cache memory 270, the CPU 110 can read in each three cycles.

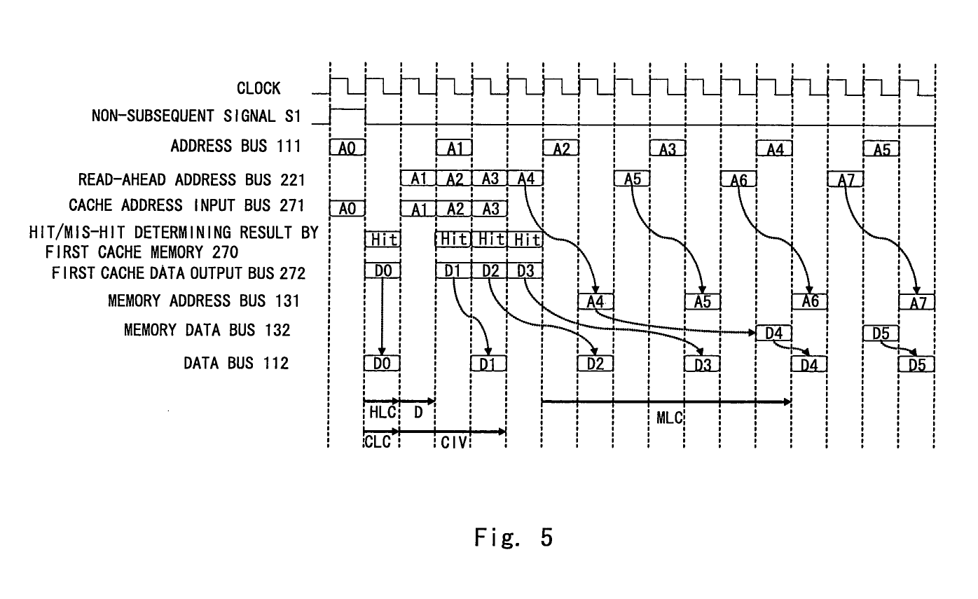

Next, the case where the respective data of a non-subsequent address and three addresses following it output from the CPU 110 are stored in the first cache memory 270 will be described with reference to FIG. 5. Assume that the non-subsequent address is address 0.

As shown in FIG. 5, because data D0 of non-subsequent address A0 is in the first cache memory 270, one cycle after the CPU 110 outputs address A0 onto the address bus 111 in the first cycle, in the second cycle, data D0 is output onto the data bus 112.

Then, in the third cycle the read-ahead address counter 220 outputs address A1 as a read-ahead address onto the read-ahead address bus 221 to read ahead, but because data D1 of address A1 is also stored in the first cache memory 270, one cycle later in the fourth cycle, address A1 and data D1 are stored into the second cache memory 280.

Hence, for address A1 which in the fourth cycle the CPU 110 outputs onto the address bus 111, one cycle later in the fifth cycle, data D1 is output from the second cache memory 280 onto the data bus 112.

Likewise, data D2, D3 of addresses A2, A3 are stored into the second cache memory 280 in the fifth and sixth cycles respectively. Then, one cycle after the CPU 110 outputs address A2 onto the address bus 111 in the seventh cycle, in the eighth cycle data D2 is output onto the data bus 112. One cycle after the CPU 110 outputs address A3 onto the address bus 111 in the 10th cycle, in the 11th cycle data D3 is output onto the data bus 112.

In the cache controller 200, for addresses A1 to A3, one cycle after the CPU 110 outputs the address, corresponding data is output onto the data bus 112. Hence, reading ahead from address A4 becomes possible in the sixth cycle, five cycles after the CPU 110 outputs address A0 onto the address bus 111.

Then, seven cycles after address A4 as a read-ahead address is output onto the first cache address input bus 271, in the 13th cycle data D4 is output onto the memory data bus 132. Hence, it is 12 cycles after the CPU 110 outputs address A0 onto the address bus 111 in the first cycle that data D4 of address A4 can be output to the CPU 110.

Where the CPU 110 reads once in each three cycles, it is in the 14th cycle, 13 cycles after address A0 is output onto the address bus 111 that data D4 of address A4 is needed. Accordingly, one cycle after the CPU 110 outputs address A4 onto the address bus 111, data D4 can be output from the second cache memory 280 onto the data bus 112.

Address A5 as a read-ahead address can be output onto the read-ahead address bus 221 three cycles after read-ahead address A4 is output onto the read-ahead address bus 221 in the sixth cycle. Hence, in the ninth cycle address A5 is output onto the read-ahead address bus 221. Then, seven cycles later, in the 16th cycle data D5 is read out from the memory 130 and stored into the second cache memory 280.

When the CPU 110 reading once in each three cycles outputs address A5 onto the address bus 111 in the 13th cycle, one cycle later the second cache memory 280 can output data D5 onto the data bus 112.

In this way, one cycle after the CPU 110 outputs a read address onto the address bus 111, the data of that address is output onto the data bus 112.

In this way, in the present embodiment, by storing the data of four addresses following a non-subsequent address in the first cache memory 270, the CPU 110 can execute instructions in fewer cycles.

That is, by determining the number n to satisfy the condition that, where the respective data of n addresses following a non-subsequent address are stored in the first cache memory 270, at the beginning of the (n+1)th one of subsequent reads following the non-subsequent read, the data of the read address of the subsequent read is already stored in the second cache memory 280 and accordingly storing the data of N (=n+1) addresses starting from a non-subsequent address in the first cache memory 270, the CPU 110 can read without reduction in performance.

In the present embodiment, the number N (an integer) can be obtained from the equation (1).

N≧(D+MLC−CLC)/(CIV−HLC), (1)

where D is time from the completion of a non-subsequent read until the next read starts (number of clock cycles); MLC is time from the start of reading from a read address of which the data is stored in neither of the first and second cache memories until outputting the data of the read address to the CPU (number of clock cycles); CLC is shortest time for a read (number of clock cycles); CIV is the frequency of reads (number of clock cycles); and HLC is time from the start of reading from a read address of which the data is stored in the first cache memory until outputting the data of the read address to the CPU (number of clock cycles).

As shown in FIG. 5, in the present embodiment, the D, HLC, MLC, CIV, and CLC are at 1, 1, 7, 3, and 1 respectively. Hence, the N is calculated as an integer of four or greater from the equation (1).

That is, with the data of four or more addresses starting from a non-subsequent address being stored in the first cache memory 270, the CPU 110 can take in the data via the data bus 112 in the smallest number of, CLC, cycles from outputting an address onto the address bus 111.

If the data of four addresses starting from a non-subsequent address are stored in the first cache memory 270, the CPU 110 can read the data in the smallest number of, CLC, cycles, and the requisite capacity of the first cache memory 270 is smallest.

Further, the second cache memory 280 need only have enough capacity to store the data of N number of read-ahead addresses, which N is obtained from the equation (1), and hence the requisite capacity of the second cache memory 280 can be reduced.

In this way, in the microcomputer 100, reduction in performance when the CPU 110 reads can be prevented with reducing the requisite capacity of the cache memories.

Moreover, the technology described in Reference 1 can be applied only to instructions and not data access for which no branch (jump) occurs. In the present embodiment, when outputting a read address, the CPU 110 outputs the signal indicating whether the read address is a non-subsequent address, and hence the invention can be applied to instruction data and other data as well.

The present invention has been described by way of an embodiment. The embodiment is illustrative, and various modifications and additions or subtractions may be made as long as not departing from the subject of the present invention. It is to be understood by those skilled in the art that variants made by the modifications and additions or subtractions fall within the scope of the present invention.

For example, although in the above embodiment the N obtained from the equation (1) is used, if N=2, the subsequent read following a non-subsequent address can be made faster, and if N=3, the subsequent read following a non-subsequent address and the next subsequent read can be made faster. That is, if N is set at two or greater (n≧1), the present invention can produce the effect.

It is apparent that the present invention is not limited to the above embodiments, but may be modified and changed without departing from the scope and spirit of the invention.

What is claimed is:

1. A cache control method comprising:
a process in which when a non-subsequent read occurs which is a read from a non-subsequent address not consecutive to the previous read address, a first cache memory sequentially caches respective data of the non-subsequent address and n addresses following the non-subsequent address, where n is an integer of one or greater, while the cached data of the n addresses are stored into a second cache memory;
a process in which subsequently, until the next non-subsequent read is performed, data of addresses following the last one of the n addresses are sequentially read from a memory, not via the first cache memory and stored into the second cache memory; and
a process in which in response to subsequent reads following the non-subsequent read, the second cache memory outputs the data of read addresses specified by the subsequent reads.

2. The cache control method according to claim 1, wherein the number n is determined to satisfy the condition that, where the respective data of n addresses following the non-subsequent address are stored in the first cache memory, at the beginning of the (n+1)th one of subsequent reads following the non-subsequent read, data of the read address of the subsequent read is already stored in the second cache memory.

3. The cache control method according to claim 2, wherein the number n is the smallest one of integers to satisfy the condition.

4. The cache control method according to claim 1, further comprising a process of, according to a non-subsequent read signal that a CPU (central processing unit) outputs together with a read address when reading to indicate whether the read is a non-subsequent read, determining whether the read is a non-subsequent read.

5. The cache control method according to claim 2, further comprising a process of, according to a non-subsequent read signal that a CPU (central processing unit) outputs together with a read address when reading to indicate whether the read is a non-subsequent read, determining whether the read is a non-subsequent read.

6. The cache control method according to claim 3, further comprising a process of, according to a non-subsequent read signal that a CPU (central processing unit) outputs together with a read address when reading to indicate whether the read is a non-subsequent read, determining whether the read is a non-subsequent read.

7. A cache device comprising:
a first cache memory;
a second cache memory; and
a read-ahead processing unit to, when a non-subsequent read occurs which is a read from a non-subsequent address not consecutive to the previous read address, have the first cache memory sequentially cache respective data of the non-subsequent address and n addresses following the non-subsequent address, where n is an integer of one or greater, while having the second cache memory store the cached data of the n addresses in itself, and subsequently, until the next non-subsequent read is performed, to sequentially read data of addresses following the last one of the n addresses from a memory, not via the first cache memory while having the second cache memory store the data in itself,
wherein in response to subsequent reads following the non-subsequent read, the second cache memory outputs the data of read addresses specified by the subsequent reads.

8. The cache device according to claim 7, further comprising:
a queue to, when receiving a read address, read data of the read address from the memory,
wherein the read-ahead processing unit comprises:
a read-ahead address counter to, when a non-subsequent read occurs, generate and hold a read-ahead address that is an address following a non-subsequent address, which is the read address of the non-subsequent read, and subsequently, until the next non-subsequent read is performed, to generate and hold the next read-ahead address that is an address following the read-ahead address having been held with outputting sequentially the generated read-ahead addresses;
a non-subsequent address holding circuit to, when a non-subsequent read occurs, read and hold a non-subsequent address, which is the read address of the non-subsequent read, with outputting the non-subsequent address being held until the next non-subsequent read is performed;
a comparator to compare the read-ahead addresses output from the read-ahead address counter and the non-subsequent address output from the non-subsequent address holding circuit and, if the read-ahead address is one of the n addresses following the non-subsequent address, to output a cache access signal indicating access to the first cache memory and in contrast, if the read-ahead address is an address subsequent to the n addresses following the non-subsequent address, to output a non-cache access signal indicating non-access to the first cache memory;
a switching circuit to, if receiving the cache access signal from the comparator, output the read-ahead address output from the read-ahead address counter to a selector for selecting an address to be output to the first cache memory and in contrast, if receiving the non-cache access signal, to output the read-ahead address output from the read-ahead address counter to the queue; and
the selector to, when a non-subsequent read occurs, output a non-subsequent address, which is the read address of the non-subsequent read, to the first cache memory and then to output the read-ahead address received from the switching circuit to the first cache memory,
wherein, when the selector outputs the non-subsequent address or the read-ahead address, the first cache memory caches data of the non-subsequent address or the read-ahead address output from the selector with outputting the data in the case of the non-subsequent address, and
wherein in response to the caching of the first cache memory and the read operation of the queue, the second cache memory stores in itself the data cached by the first cache memory and data read by the queue from the memory that corresponds to the read-ahead address received from the switching circuit.

9. The cache device according to claim 7, wherein the number n is determined to satisfy the condition that, where the respective data of n addresses following the non-subsequent address are stored in the first cache memory, at the beginning of the (n+1)th one of subsequent reads following the non-subsequent read, data of the read address of the subsequent read is already stored in the second cache memory.

10. The cache device according to claim 8, wherein the number n is determined to satisfy the condition that, where the respective data of n addresses following the non-subsequent address are stored in the first cache memory, at the beginning of the (n+1)th one of subsequent reads following the non-subsequent read, data of the read address of the subsequent read is already stored in the second cache memory.

11. The cache device according to claim 9, wherein the number n is the smallest one of integers to satisfy the condition.

12. The cache device according to claim 10, wherein the number n is the smallest one of integers to satisfy the condition.

13. The cache device according to claim 7, wherein the read-ahead processing unit determines whether a read is the non-subsequent read according to a non-subsequent read signal that a CPU (central processing unit) outputs together with a read address when reading to indicate whether the read is a non-subsequent read.

14. The cache device according to claim 8, wherein the read-ahead processing unit determines whether a read is the non-subsequent read according to a non-subsequent read signal that a CPU (central processing unit) outputs together with a read address when reading to indicate whether the read is a non-subsequent read.

15. The cache device according to claim 9, wherein the read-ahead processing unit determines whether a read is the non-subsequent read according to a non-subsequent read signal that a CPU (central processing unit) outputs together with a read address when reading to indicate whether the read is a non-subsequent read.

16. The cache device according to claim 10, wherein the read-ahead processing unit determines whether a read is the non-subsequent read according to a non-subsequent read signal that a CPU (central processing unit) outputs together with a read address when reading to indicate whether the read is a non-subsequent read.

17. The cache device according to claim 11, wherein the read-ahead processing unit determines whether a read is the non-subsequent read according to a non-subsequent read signal that a CPU (central processing unit) outputs together with a read address when reading to indicate whether the read is a non-subsequent read.

18. The cache device according to claim 12, wherein the read-ahead processing unit determines whether a read is the non-subsequent read according to a non-subsequent read signal that a CPU (central processing unit) outputs together with a read address when reading to indicate whether the read is a non-subsequent read.

19. A microcomputer comprising:
a CPU (central processing unit);
a memory; and
a cache device according to claim 7 connected between the CPU and the memory.

20. A microcomputer comprising:
a CPU (central processing unit);
a memory; and
a cache device according to claim 8 connected between the CPU and the memory.
